(19) United States
(12) Patent Application Publication
(10) Pub. No.: US 2013/0325648 A1
(43) Pub. Date: Dec. 5, 2013

(54) Wearable Article For the Concealment of Personal Items

(71) Applicant: Sonia Kanner, San Diego, CA (US)

(72) Inventor: Sonia Kanner, San Diego, CA (US)

(21) Appl. No.: 13/905,100

(22) Filed: May 29, 2013

Related U.S. Application Data
(60) Provisional application No. 61/652,804, filed on May 29, 2012.

(51) Int. Cl. A41D 27/20; G06Q 30/06

(52) U.S. Cl. CPC A41D 27/205; G06Q 30/0621
USPC 705/26.5; 2/69

(57) ABSTRACT

A clothing article having pockets for personal articles such as identification cards and credit cards is provided and method for a user to self-design a customized version thereof. The clothing article features an elastic base for engagement to the body of a user, and one or a plurality of hidden or discernible pockets to carry user articles. A pocket container which holds the articles may also be employed.

This application claims priority to U.S. Provisional Application No. 61/652,804 filed on May 29, 2012, and is incorporated herein in its entirety.

### BACKGROUND OF THE INVENTION

1. Field of the Invention

The present invention relates wearable articles for the concealed transport of personal items at differing functions with differing clothing requirements, and a business method empowering customers for such clothing to design such to fit their individualized need. More particularly, the invention relates to a wearable fashion article which can be worn under or over clothing which employs pockets for storage of personal items and the related business method which allows users to customize the device with logos, colors, as well as the number and configuration of pockets for their individual requirements such as right or left handedness, during an online purchase.

2. Prior Art

With the increase in personal property theft, especially among women, the carrying of personal belongings and cash and identification in a purse, or pocketbook, is becoming less and less desirable. Purses are especially targeted by thieves since it is conventionally known that purses generally contain an abundance of personal items, valuables, credit cards, and other identifying material belonging to the purse owner. Additionally, pickpockets and individuals skilled at removing wallets and pocketbooks and valuables from a person's pocket or person while they are distracted are especially attracted to purses and handbags due to their separation from the body of the person providing a dampening of their contact during removal of items.

In addition to thievery, individuals carrying purses or keeping items in a pocket are often prone to losing such items while simply progressing through their day to day life. Such a loss can easily happen when such persons reach into a pocket to remove one item, and inadvertently drop money or valuables from the same pocket as they remove their hand. Often, the loss of personal items due to theft or negligence can result in added emotional damage due to items lost and monetary damages from thieves who gain credit card and bank account information.

This can occur because the lost personal items provide the thief with sufficient personal information to access monetary and other assets of the owner. Owner anxiety only increases over time subsequent to such a loss while they are waiting for potential new problems to occur where such information has been used. Where damages result from dropping or otherwise losing cash, the monetary damage is quite apparent.

Additionally, there are simply occasions when women, as a general rule, do not wish to carry a purse due to fashion or venue or clothing reasons. For example, some clothing has no pockets such as tight pants, or the like, which may be worn to a sporting event or on a hike. It has been found for such events as a sporting event, where identification may be required to buy beverages, and a source of payment may be required for such beverages and transport to and from the venue, that many women bring a credit card, a debit card, and an identification card in order to minimize what needs to be carried.

However, should a wearer's fashion choice dictate clothing with no pockets, such as form-fitting pants and a top, or a swimsuit, or similar attire which is pocket-challenged, the wearer is left with a problem of where to store the two or three plastic cards noted above. Many a license and credit card in such instances is stored in a brassier which is known to be uncomfortable and be prone to loss if the wearer assumes a posture where she may be leaning forward.

As a conventional solution, prior art has attempted to provide garment or other wearable devices with hidden storage pockets or other onboard locations for concealing personal items.

However, these device fail to provide adequate concealment of the multitude of personal items an individual may carry. Additionally, previous art has failed to be fashionable and personally customizable to the physical as well as wardrobe requirements of the individual user, thereby causing inhibited employment thereof.

As such, there is a continuing unmet need for a wearable fashion article which provides the wearer means for storage and for hidden concealment of personal items. Further, such a device should be customizable by the user during ordering, to their physical and wardrobe requirements, using an easy to understand and employ a graphic, interface which allows for a high degree of user-customization, irrespective of language skills. Additionally, during the ordering process, the device herein should reach the user-customized configuration easily through the employment of a graphic interface as a means to customize the device with logos, number and location of pockets, color, left or right handedness for access to pockets and removable pockets, and other customizable features.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art of valuable-concealment and achieves the above noted goals through the provision of wearable fashion article, configured for engagement about a user waist or hips, which is configured to provide a viewable and hidden pocket for valuables as well as a transportable pocket which may be transferred to other pockets and back again in a secured fashion.

The device is user-customizable to position and employ pockets or other means for concealed housing of personal items. In ordering of the device, the user or wearer may be provided using a graphic interface using software running on a network accessible server or computer, which is rules-based and communicates a video depiction graphic interface to the user's computer, to allow for choosing and the placement of pockets upon the base layer in a manufacturable fashion. The device so customized, can be worn hidden underneath or over conventional garments. Additional choices may also be made by the user or wearer on ordering or buying the device with regard to right and left hand access to pocket contents and hidden transferable pockets for ID and such which have an elastic lanyard available to maintain them in proximity to their pocket of deposit.

In accordance with a first preferred mode, the device is formed from conventional garment materials configured as a band or belt which can be worn around users hips or waist in an as-word position. The device can be formed from one or a combination of woven, knitted, or unwoven textile materials such as nylon, lycra, silk, cotton, polynosic rayon, or other natural, synthetic, or organic textile fabric conventionally known in the art. Currently a fabric formed of 90% micropoly and 10% lycra elastic and moisture wicking fabric is particularly favored to allow the device to be worn around the waist or torso and be wrapped in a stylish yet thin and compact fashion on the user.

It is preferred that the material is slightly if not moderately elastic when worn to allow for an adaptable encirclement of a portion of the wearer's body, such that the device can be a ‘one-size-fits-all’ type of article. Further, employing elastic material will allow the user to stretch the device over their waist or hips, such that the elasticity will stretch the fabric to form a bias and curve hugging configuration and thereby maintain the device against the users hips or waist in a secured as worn position.

The device preferably includes a first (inner) surface, a second (outer) surface, and first (top) edge, and second (bottom) edges. In use, the inner surface is engaged adjacent to the surface of the users body and the outer surface is exposed, and opposite the inner surface. The device can be formed from a plurality of layers of materials which are engaged by sewing or other means about the periphery of the top and bottom edges, or can be a single layer of material. Padding may also be employed as a layer between the outer and inner surfaces if desired for comfort.

The device preferably includes one or a plurality of pockets engaged to one or a combination of the outer surface, inner surface, or layer positioned therebetween, providing a means to contain and conceal personal items such as a wallet, keys, money, etc. Additionally a transportable hidden pocket container may be positioned in the hidden or other pocket, and transported to another garment with its contents inside. An elastic lanyard may be provided to anchor the pocket container in its nesting pocket, and, depending on the side of the device on which the hidden pocket is located, a corner portion of the pocket container allows access for a finger and thumb to remove a card contained therein. The corner portion is chosen depending on wether a right or left hand of the user will reach into the hidden pocket. The location and quantity of the pockets are preferably of the users choice to match their requirements and thus can vary.

In accordance with a preferred method for purchasing the device as described above, software adapted to the task and accessible through a server, will provide users with viewable remote display on a video screens powered by a connected computer or in communication with the computer running the ordering software, such as through a kiosk, personal computer, or smart phone. The software is rules-based in that it operates using rules as to how big, and how many, of user chosen pockets may be included, and where on the formed garment device, the pockets can be placed during manufacture, while still accommodating seams and such.

The graphic interface communicated to and depicted on the buyer's video display, will depict to users or buyers, fields or icons of the graphic interface for selecting size, quantity and style of pockets, logos, and colors using an input device such as a mouse. Using the input device, indicia or icons or the like of the graphic interface, may be captured by moving the cursor with the input device. In this fashion the icons or graphics representing the different pockets and logos may be dragged and positioned by the user over a display of an uncustomized (plain) form of the device, for a custom positioning by each user.

Once the user is finished using the graphic interface to add pockets and logos and the like, to the base portion of the formed device, software adapted of rendering the user-designed device, may provide a virtual preview for display and viewing by the user on their video display. The graphically depicted virtual finished device allows the user review their selections for aesthetics and function. As such a user can select a desired logo or image, pocket and pocket or logo position allowed by the rules which are based on manufacturing concerns, and compare that to a selected color, and pockets and positioning to ascertain if the combination is of their liking.

Further, the user may be given the choice of including a pocket container which nests in the hidden pocket and allows for containment of one or a plurality of ID and credit cards therein, and cash. Additionally offered will be an elastic lanyard secured between the pocket container and the chosen nesting pocket for that container, and, an angled corner portion exposing one corder of the contained cards, to allow for retrieval by the thumb and opposing finger of the user thereon. The pocket container with the lanyard may be moved to other base garments having the lanyard attachment and hidden or other pocket sized to receive it.

While in the preferred mode, the user or buyer is allowed to design and purchase the device customized to their liking, using the graphic interface, the device can also be provided in standard versions and standard versions adapted for right and left handed users and purchased in a normal fashion off the rack.

Further, using rules based on possible manufacturing, and a relational database of achievable configurations, the software is adapted to the task of prompting the user, if they have selected a pocket or logo or other combination which is unachievable due to the restricted surface area of the base device, or other manufacturing and component concerns. For example, if too many pockets or logos were chosen which cannot physically fit into the space of the device during manufacture, such a prompt may indicate that some selections must be removed.

In addition, a graphic interface for remote display may be provided as a means which allows the user/buyer to order the customized device, and have it sent to the desired address, or have it scheduled for pickup at a retail store. The user may pay via credit card, debit card, electronically transfer funds, or pay cash.

In a method herein for customizing the device by the user or buyer, and employing software running on a computer which will communicate and respond to commands input on a graphic interface portrayed on a display screen of, or in front of the buyer, and adapted to the task of allowing the device to be configured, a means for customized design and selling a user or buyer-customized fashion article of the present invention, is provided using the steps of:

having a user select from a group of customizable options including hidden and viewable pockets, placement of chosen pockets, pocket containers, right or left handed access to contents, elastic lanyards and other choices;

using rules regarding the area of the base component required to accommodate a chosen pocket, and area from edges and seams required for pocket placement to define permissible areas for placement of hidden and/or conventional pockets, to ascertain if a user chosen configuration is achievable;

if a problem exists with a user chosen configuration rendering the chosen configuration outside the areas of the device where the choices are employable, then prompting the user to change it, or preventing the user from employing the software to make the configuration and prompting a change;

if the chosen configuration fits the rules for placement of the components chosen, then, providing a graphic interface or graphic depiction of a virtual depiction of the user-configured fashion article for a final review by the buyer/user; and

requesting a user input as a confirmation that the user is satisfied with their selected choices as depicted virtually;

subsequent to receipt of the confirmation input, providing a means for the user to pay for the article; and

providing means to ship the article to a user chosen destination.

As noted above, while customization with user input is favored, the device may be manufactured in standard modes and users allowed to chose pre manufactured versions of the device herein.

With respect to the above description, before explaining at least one preferred embodiment of the herein disclosed invention in detail, it is to be understood that the invention is not limited in its application to the details of construction and to the arrangement of the components, or of the steps of the method for selling the article in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

Objects of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows front view of the device having a logo and pockets engaged thereon and showing optional left and right handed pocket containers for ID and credit or debit cards.

FIG. 2 shows a top view of the device.

FIG. 3 depicts a cross sectional view of the device as viewed from line AA of FIG. 2, showing a first preferred mode wherein the device is formed from a single layer of fabric.

FIG. 4 depicts a cross sectional view of the device as viewed from line AA of FIG. 2, showing another preferred mode wherein the device is formed from a plurality of layers of fabric.

FIG. 5 shows a flow chart view of the method of employing software adapted at the task of providing the user with a graphic interface for customizing the device.

FIG. 6 show an graphic interface display providing the user with means to click and drag customizable options depicted as icons, onto the view of the device by making selections such as to size, logos, colors, and pockets and pocket containers with or without lanyards.

FIG. 7 shows a view of a graphic interface displaying a preview of the device as customized by the user for a preview prior to final purchase.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

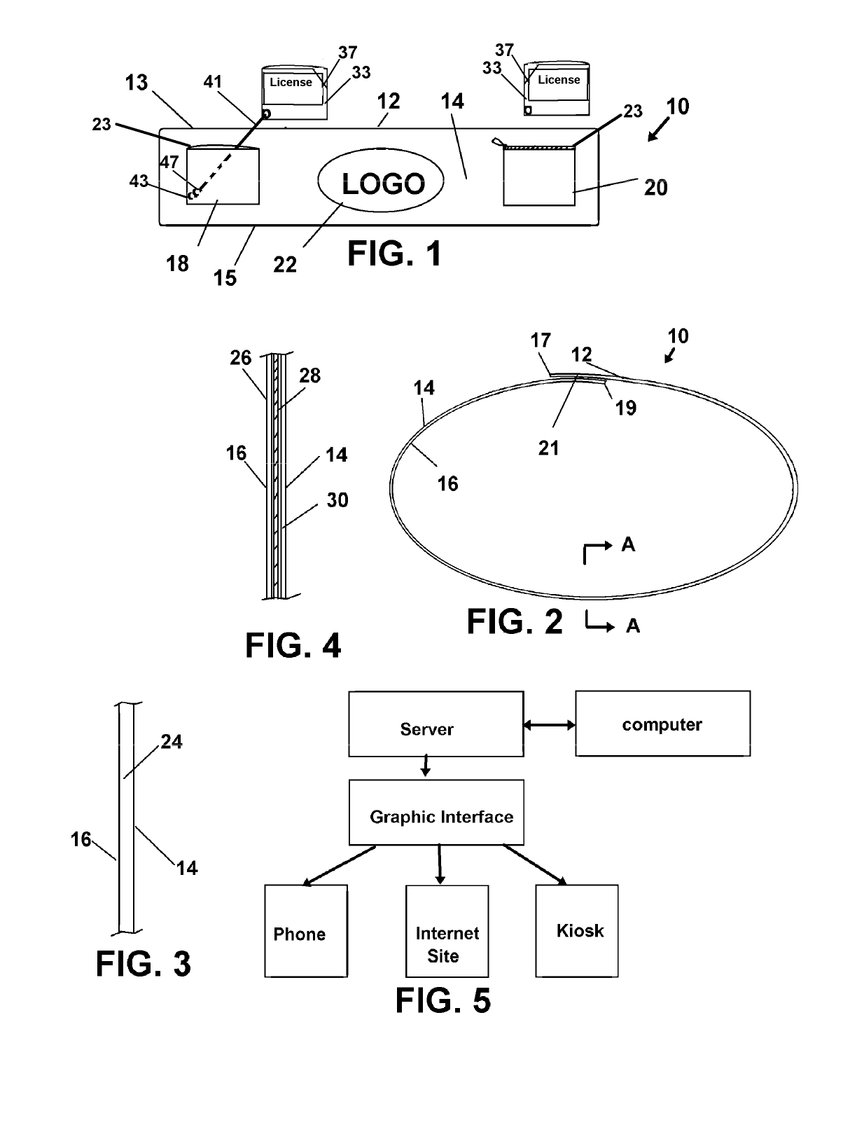

Now referring to drawings in FIGS. 1-7, wherein similar components are identified by like reference numerals, there is seen in FIG. 1 and FIG. 2 views of a preferred mode of the device 10 which as noted may be manufactured in certain preconfigured modes for right and left handed users, or may be sold in a method where the user chooses the configuration based on their personal style, wardrobe colors, and right or left handedness.

The device 10 may be comprised of a planar band 12 of garment material preferably with a degree of elasticity to better stretch to the form of the user when wrapped thereon. The various components of the device 10 disclosed herein can be formed of conventional materials adapted for assembly by sewing, stitching, heating, adhesive assembly, or other means for formation of the finished device, such as woven, or knitted materials, or non-woven fabrics formed of synthetic or organic fabrics. However the device 10 herein can be formed of one or a combination of the above or any woven or non woven material or fabric suitable for the purposes set forth in this disclosure.

The formed base or elastically engageable band 12 for engagement to the body of the user, is configured for stretched engagement around a users hips or waist in an as-used position, where it is worn over other clothing or underneath conventional clothing, such as coats or sweaters or shirts so as to be hidden from view.

The band 12 includes an outer surface 14 having apertures 23 providing access to the circumferential opening to internal cavities of one or a plurality of formed pockets such as hidden pocket 18, and discernible pocket 20, engaged to the band 12. Access through the apertures communicating with the pockets 18 or 20, provide means for storing and concealing personal items of the wearer safely until retrieved and out of view by third parties. If the pocket is a hidden pocket 18 the aperture 23 will be formed in a fold or seam or edge of the band 12 to render it indiscernible.

Pockets 18, 20, can vary by size, shape, and closure means, such as closure by separable fastener such as a zipper closure 20, or no closure 18 which simply leaves an aperture 23 for communication into the pocket 18,20. However other closure means can include one or combinations of any separable fastener such as snaps, hooks, hook and loop fastener, buttons and button holes, cinches, or other cooperative but separable fasteners of the like.

The inner surface 16 facing or abutting the user's body, may be include a non irritant material such as felt or a coating as to comfortably engage against the user bare skin if necessary. The band 12 can be formed by providing a strip of planar woven or non woven material and sewing or otherwise engaging the ends 17, 19 of the material together. Shown in FIG. 2 is an example of an overlapped engagement 21 which can be stitched or engaged by other means known in the art such as adhesives, snap fits, or the like.

FIG. 3 shows a cross sectional view depicting one preferred mode of the formed device 10 comprising a single layer 24 of woven, knitted, or unwoven textile fabric or garment material.

In FIG. 4 is shown another mode wherein the device 10 where the band 12 comprises a plurality of layers of the textile materials, such as an inner layer 26 proximate to or forming the inner surface 16, an intermediate layer 28 located in the formed cavity between the inner layer 26, and an outer layer 30, which is proximate to or forms the outer surface 14. In this mode the device 10 can be formed by sewing or otherwise engaging the top and bottom peripheral edges 13, 15 of the layers to engage all the layers together. Further, in a preferred mode the intermediate layer 28 may be padding or the like to add comfort.

In a preferred mode of the device 10 which may be sold pre-configured, at least one pocket, be it a hidden pocket 18 or discernible pocket 20 is engaged operationally with the formed band 12 of material, such that an aperture 23 provides access to an interior cavity of the pocket. Currently a hidden pocket 18 is particularly favored as it provides a means to conceal from the view of third parties, the position on the band 12 occupied by identification, credit cards, debit cards, cash, or other personal or valuable items. Also preferred in this mode, is the provision of a pocket container 33, having two sidewalls and an internal cavity, and sized for easy insertion through the aperture 23 into a nesting position held by the interior cavity of the hidden pocket 18. In this nesting position, the pocket container 33 would preferably be transparent material or at least have one sidewall being transparent, such that an identification positioned inside the internal cavity of the pocket container 33 can be read and viewed through the transparent sidewall.

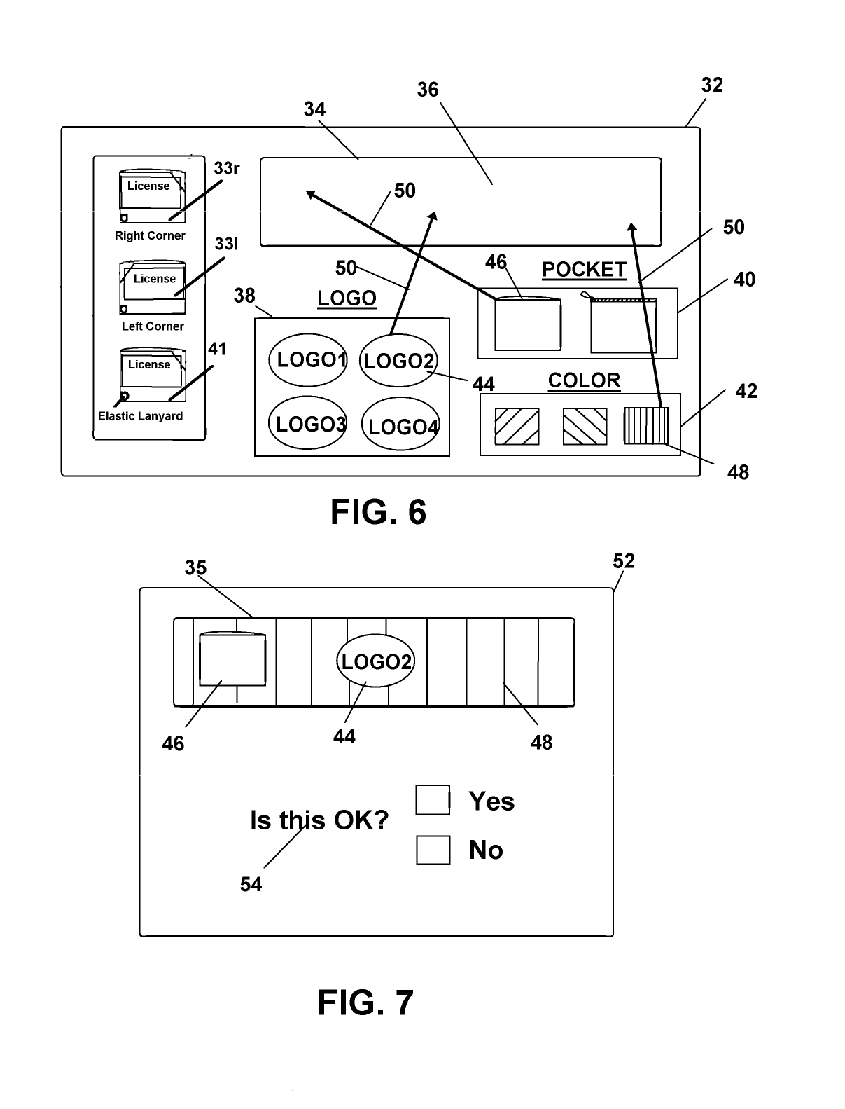

Additionally preferred, is the angled edge 37 of one or both sidewalls of the pocket container 33, on one side or the other of the pocket container 33, depending on which hand of the user is to reach into the hidden pocket 18, to remove the card or license or ID from the pocket container 33 and the position of the hidden pocket 18 or pocket. A user having the hidden pocket 18 on the right of the front side of their body, would want a pocket container 33r (FIG. 6) having the angled edge 37 the right side of the pocket container 33 when looking at a front surface thereof. In that fashion they may easily reach across their body with their left hand, and feel the card extending from the angled edge 37, and remove it or the pocket container 33 with the felt card.

A user placing the hidden pocket 18 or other pocket containing a pocket container 33 would want the pocket container 331 (FIG. 6) angled edge 37 on the opposite side, such that they may reach across their body with their right hand, and into the pocket 18 and may then easily feel or remove the cards extending past the angled edge 37.

This choice is especially important if the preferred addition of an elastic lanyard 41 is added to engage and hold the pocket container 33 in the pocket in which it is nested. The elastic lanyard 41 would be formed of rubber rope or bungee type material, and engaged on a first end with the pocket container 33 and at a distal end, is engaged to a mount 43 in the chosen pocket 18 or 20, by an attachment component 47 engaged to the distal end of the elastic lanyard 41.

So engaged, the pocket container 33 is not easily pickpocketed since it must be forced with sufficient bias to overcome the force of the elastic lanyard 41 to stretch it to remove the pocket container 33. Further, the user can easily reach into either type pocket 18 or 20 and feel the ID card or credit card corner, projecting at the angled edge 37, and pull the card or ID from the pocket container 33 without it coming un-nested from the pocket 18 or 20 in which it nests. To return the card or ID, the user my pull the pocket container 33 to stretch the elastic lanyard 41, or slip the card back therein while it nests in a pocket 18 or 20.

Thus the angled edge 37 with elastic lanyard 41 allows great utility and deft action by the user to pull and use and ID or credit card without showing the pocket to third parties as would be normal when they have to reach in and try and figure out what is in a pocket and how to get it out.

It is noted and anticipated that the device 10 may employ more or less than the plurality of layers shown in the figure, and as such should not be considered limited by the depictions.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

FIG. 5 shows a schematic view of the a particularly preferred method for providing users or buyers an manner to custom design their device 10, which is then manufactured or provided from pre manufactured devices 10 in storage, per their specific choices. Employing the method herein, each final configuration of each device 10 for the user buying it, may be customized by that user. In this favored mode, a plurality of sequentially depicted graphic interfaces configured to the task of user choices for garment assembly, using icons in depictions are communicated to a viewing screen of the users who will generally be at a remote location communicating over a network.

This is accomplished by employing a computer or computer server engaged with and communicating across a network such as the internet, with the user/buyer's computer. The system herein employs software adapted to the task of communicating graphic interfaces to the user/buyer's computer or other display such as smart phones, home computers, or remote kiosks having a computer and display. For example a kiosk can be provided at a sporting venue, and provide the buyer/user the ability to use a selection device such as a mouse and cursor, to make selections of icons representative of team logos, colors, pockets, pocket containers, elastic lanyards, etc. by “dragging” them to desired positions on the band 12.

The software provides the graphic interfaces in an order to allow the user a means for customizing the device 10 to their particular liking, body style, and right or left handedness, and subsequently purchase and obtain the customized version of the device 10. A relational database and/or rules-based software which will have rules concerning placement of pockets and logos on the base, pursuant to required spacing from edges and each other, will not allow the user to move the icons representing pockets, and logos, and other options to assemble a device 10 on their local viewed display, which cannot be manufactured as displayed as a virtual device 10.

FIG. 6 shows a mode of a first display 32 communicated over a network, to the user on a phone, computer screen, a kiosk, or the like. The depiction shows a virtual image 34 of the device 10 having a blank or plain outer surface 36 of the band 12. The user is then provided with a plurality of icons representing the chosen option, to select a desired logo 38, a pocket quantity and style 40 and positioning on the band 12 thereof, and one or a plurality of colors 42, a pocket container 33, a lanyard 41, or right or left sided angled edges 37 depending on their anticipated mode of entering a pocket 18 or 20 to remove ID or a credit card or debit card. Those skilled in the art will recognize that other options may additionally be available such as size, width and the like as needed to customize the device 10, and graphic interfaces to provide the user/buyer with such additional options are anticipated.

The user can then selectively use their mouse or other input device to select and drag 50 their icon representative selection onto the surface 36 of the virtual band 12 of a device 10 depicted in the graphic interface image 34 through the employment of a computer mouse curser, or touch screen enable interface. For example a particular logo 44, pocket type 46, pocket positioning and number, pocket containers 33 and angles 37 and lanyards 41 and one or a plurality of colors 48 may be chosen and selectively positioned on the image 34.

Shown in FIG. 7 is a display 52 showing the customized image 35 of the device 10 as determined from the users selections. This will allow the user to review the selections for aesthetics and function prior to purchase. As noted, rules based software operating the graphic interface and/or a relational database of achievable configurations are employed to prevent the user/buyer from graphically assembling a device which cannot be manufactured. A prompt 54 may be provided to inform the user of an unachievable design and/or to allow the user to accept or deny their particular customization and return to change or cancel the customization. Addition displays may also be provided employing software adapted to the task of taking payment means, as well as delivery information or order pickup confirmation.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A clothing article having pockets for personal articles such as identification cards and credit cards, comprising:
a base, said base formed of elastic fabric adapted to stretch in a wrap around the body of a user to an as-used position held in place by a frictional elastic compressive engagement;
said base having a first side surface configured for contact with the body or clothing of said user;
said base having a second side surface, opposite said first side surface, and accessible in a hand contact therewith by said user;
an aperture communicating with said second side surface and the circumferential edge of a formed pocket;
said pocket having an interior cavity defined by a sidewall extending away from said circumferential edge;
a pocket container having two sidewalls forming an internal cavity therebetween accessible from an opening at one end of said pocket container, said pocket container sized for insertion through said aperture for a nesting engagement within said interior cavity of said pocket;
said internal cavity defining a carrier for user personal items including one or a plurality from a group of personal items including identification cards, debit cards, credit cards and cash;
said pocket container removably engageable in a said insertion through a said aperture for a said nesting engagement within a said interior cavity of any of a plurality of said bases having a said pocket having a said interior cavity communicating with either said first side surface or said second side surface, whereby a said user having said personal items within a said internal cavity of a said pocket container, can reposition said pocket container and personal items, to a said nesting engagement with any of said plurality of bases.

2. The clothing article of claim 1 additionally comprising:
one of said sidewalls of said pocket container having an angled edge portion adjacent said opening, said angled portion defining an open area;
said angled edge positioned to place said open area in a position providing an exposure of a corner portion of any card shaped said personal item translated through said opening into said internal cavity;
said open area providing a gripping position for said user to tactually locate and form a compressive engagement of a said corner portion of any said card shaped personal item, between a thumb and opposing figure of a hand of said user, for a pulling from said internal cavity, whereby said user without a viewing of said card shaped personal item, can touch said corner portion to locate it and thereafter engage it between said thumb and opposing finger for removal.

3. The clothing article of claim 1 additionally comprising:
an elastic lanyard engaged on a first end to said pocket container and on an opposite end, with an anchor point within a said interior cavity of a said pocket;
said elastic lanyard resisting movement of said pocket container in an exiting of said nesting engagement; and
whereby said pocket container provides a restraint for maintaining said pocket container hidden within a said internal cavity, wherein personal items of said user within a said pocket container are prevented by an accidental dropping or deliberate pickpocketing removal from said pocket by said lanyard resisting said movement of said pocket container.

4. The clothing article of claim 2 additionally comprising:
an elastic lanyard engaged on a first end to said pocket container and on an opposite end, with an anchor point within a said interior cavity of a said pocket;
said elastic lanyard resisting movement of said pocket container in an exiting of said nesting engagement; and
whereby said personal items of said user in a frictional engagement within said internal cavity of said pocket container may be pulled therefrom by said user forming said compressive engagement and initiating said pulling thereof, while said pocket container remains tethered within said pocket by said elastic lanyard, hidden from third party view.

5. The clothing article of claim 1 additionally comprising:
said aperture communicating with said second side surface in a fold or under covering portions of said second side surface in a hidden position from viewing; and
said hidden position rendering said pocket a hidden pocket.

6. The clothing article of claim 2 additionally comprising:
said aperture communicating with said second side surface in a fold or under covering portions of said second side surface in a hidden position from viewing; and
said hidden position rendering said pocket a hidden pocket.

7. The clothing article of claim 3 additionally comprising:
said aperture communicating with said second side surface in a fold or under covering portions of said second side surface in a hidden position from viewing; and
said hidden position rendering said pocket a hidden pocket.

8. The clothing article of claim 4 additionally comprising:
said aperture communicating with said second side surface in a fold or under covering portions of said second side surface in a hidden position from viewing; and
said hidden position rendering said pocket a hidden pocket.

9. The clothing article of claim 5 additionally comprising:
said aperture communicating with said second side surface in a fold or under covering portions of said second side surface in a hidden position from viewing; and
said hidden position rendering said pocket a hidden pocket.

10. The clothing article of claim 2 wherein said pocket protector is configured for easier employment by said user accessing of said pocket with a left hand, additionally comprising:
said one of said sidewalls of said pocket container having an angled edge portion adjacent a said opening situated on a first side of said pocket container, opposite a second end; and
said first end positioned closer to said left hand than said second end, when said pocket container is positioned in a said nesting engagement.

11. The clothing article of claim 3 wherein said pocket protector is configured for easier employment by said user accessing of said pocket with a left hand, additionally comprising:
said one of said sidewalls of said pocket container having an angled edge portion adjacent a said opening situated on a first side of said pocket container, opposite a second end; and
said first end positioned closer to said left hand than said second end, when said pocket container is positioned in a said nesting engagement.

12. The clothing article of claim 4 wherein said pocket protector is configured for easier employment by said user accessing of said pocket with a left hand, additionally comprising:
said one of said sidewalls of said pocket container having an angled edge portion adjacent a said opening situated on a first side of said pocket container, opposite a second end; and
said first end positioned closer to said left hand than said second end, when said pocket container is positioned in a said nesting engagement.

13. The clothing article of claim 2 wherein said pocket protector is configured for easier employment by a said user accessing of said pocket with a right hand, additionally comprising:
said one of said sidewalls of said pocket container having an angled edge portion adjacent a said opening situated on a second side of said pocket container, opposite a first end; and
said second end positioned closer to said right hand than said first end, when said pocket container is positioned in a said nesting engagement.

14. The clothing article of claim 3 wherein said pocket protector is configured for easier employment by a said user accessing of said pocket with a right hand, additionally comprising:
said one of said sidewalls of said pocket container having an angled edge portion adjacent a said opening situated on a second side of said pocket container, opposite a first end; and
said second end positioned closer to said right hand than said first end, when said pocket container is positioned in a said nesting engagement.

15. The clothing article of claim 4 wherein said pocket protector is configured for easier employment by a said user accessing of said pocket with a right hand, additionally comprising:
said one of said sidewalls of said pocket container having an angled edge portion adjacent a said opening situated on a second side of said pocket container, opposite a first end; and
said second end positioned closer to said right hand than said first end, when said pocket container is positioned in a said nesting engagement.

16. A method allowing a user to custom configure the device of claim 1, comprising the steps of:
communicating a video display to a user contacting a server running software for communicating with said users and communicating graphic display screens to a viewable screen of said user;
communicating a said graphic display to a computing device having a display screen, a graphic interface allowing said user a selection from a group of customizable options including, a base component, hidden and viewable pockets, placement of chosen said hidden or said viewable pockets, employment of pocket containers, a choice between right or left handed access to contents, a choice between no restraint of said pocket container and elastic lanyards engaged with said pocket containers and said pocket;
allowing said user to move icons on a said graphic display screen configured to communicate a response of user choices for said options, and a positioning thereof;
employing software running on a computer and configured with rules regarding spacing of said options from each other and from positions on said base, to determine an authorized area on said base, for each respective chosen customizable option of a configuration chosen by said user;
ascertaining if a problem exists with a user chosen configuration which positions a said customizable option outside said authorized area of said base;
if said choices are not employable, then prompting the user to change it, or preventing the user from employing the software to make the desired configuration and prompting a change;
if the chosen configuration fits within said authorized area for placement of the components chosen, then, providing to said user, a graphic interface or graphic depiction of a virtual depiction of the user-configured fashion article for a final review by the buyer/user; and
thereafter, requesting a user confirming input as a confirmation that the user is satisfied with their selected choices as depicted virtually;
subsequent to receipt of the confirming input, providing a means for electronic payment by the user to pay for the article; and
providing a shipment of the article to said user.
